(19) United States
(12) Patent Application Publication
(10) Pub. No.: US 2024/0379949 A1
(43) Pub. Date: Nov. 14, 2024

(54) NEGATIVE ELECTRODE ACTIVE MATERIAL FOR LITHIUM SECONDARY BATTERY, METHOD OF PREPARING THE SAME, AND LITHIUM SECONDARY BATTERY INCLUDING THE NEGATIVE ELECTRODE ACTIVE MATERIAL

(71) Applicant: KANGWON NATIONAL UNIVERSITY INDUSTRY COOPERATION FOUNDATION, Chuncheon-si (KR)

(72) Inventors: Sung Man LEE, Hanam-si (KR); Dong Young JUNG, Cheongju-si (KR)

(73) Assignee: KANGWON NATIONAL UNIVERSITY INDUSTRY COOPERATION FOUNDATION, Chuncheon-si (KR)

(21) Appl. No.: 18/782,892

(22) Filed: Jul. 24, 2024

Related U.S. Application Data
(63) Continuation of application No. PCT/KR2022/012837, filed on Aug. 26, 2022.

(51) Int. Cl. H01M 4/36; C01B 32/21; H01M 4/02; H01M 4/587; H01M 10/0525

(52) U.S. Cl. CPC H01M 4/366; C01B 32/21; H01M 4/587; H01M 10/0525; C01P 2004/03; C01P 2004/32; C01P 2004/50; C01P 2004/80; C01P 2006/40; H01M 2004/027

(57) ABSTRACT

Provided are a negative electrode active material for a lithium secondary battery, a method of preparing the same, and a lithium secondary battery including the negative electrode active material. The negative electrode active material includes spheroidized natural graphite particles, wherein the spheroidized natural graphite particles have a structure in which flaky natural graphite fragment particles are grouped and assembled in a cabbage shape or random shape, and a phosphorus (P) atom is bonded to an edge plane of each of all or some particles of the flaky natural graphite fragment particles to modify the spheroidized natural graphite particles, and a portion or the entirety of a surface of the modified spheroidized natural graphite particle is coated with amorphous and/or low-crystallinity carbon.

### CROSS-REFERENCE TO RELATED APPLICATION

This application is a continuation of International Application No. PCT/KR2022/012837 filed on Aug. 26, 2022, the entire contents of which are herein incorporated by reference.

### TECHNICAL FIELD

The present invention relates to a negative electrode active material for a lithium secondary battery, a method of preparing the same, and a lithium secondary battery including the negative electrode active material for a lithium secondary battery.

### BACKGROUND ART

The demand for lithium secondary batteries is rapidly increasing as an energy source not only for mobile devices but also for electric vehicles, and in relation to the expansion of an application range thereof, there is a need to improve the stability and long lifespan characteristics of lithium secondary batteries at high temperature.

Currently, crystalline graphite materials are used as negative electrode active materials for lithium secondary batteries, and crystalline graphite is classified into artificial graphite and natural graphite. Due to relatively superior high-temperature lifespan characteristics and swelling characteristics as compared to natural graphite, the use of artificial graphite is increasing. However, the artificial graphite is usually obtained through a process of heating and carbonizing a carbon precursor at a high temperature of about 2,800° C. or more in an inert atmosphere to remove impurities and perform graphitization, and thus there is a problem in that manufacturing costs are high, and due to a limitation in graphitization, lithium storage capacity is slightly lower than that of natural graphite.

Meanwhile, currently commercialized natural graphite is used by grouping flaky natural graphite fragment particles in a cabbage shape or random shape to aggregate the flaky natural graphite fragment particles in a spheroidized shape, and then coating a surface thereof with amorphous and/or low-crystallinity carbon and has an advantage in that the natural graphite has slightly higher lithium storage capacity and a lower price as compared to artificial graphite.

However, in the case of spheroidized natural graphite coated with the amorphous and/or low-crystallinity carbon, there is a problem in that performance is significantly reduced due to gas generation and a swelling phenomenon due to side reactions with an electrolyte. Since such a phenomenon becomes more severe when charging/discharging is repeated at a high temperature of 45° C. or more or is maintained for a long time, an application range of lithium secondary batteries including the spheroidized natural graphite coated with the amorphous and/or low-crystallinity carbon is limited.

The side reaction is caused by an electrolyte decomposition reaction that occurs in flaky natural graphite fragment particles constituting a surface and interior of the spheroidized natural graphite particles due to cracks occurring in an amorphous and/or low-crystallinity carbon coating layer on a surface of the spheroidized natural graphite particles as charging/discharging is repeated. In particular, edge sites, which are active sites of the flaky natural graphite fragment particles, are known to further promote the electrolyte decomposition reaction.

There is a need to develop a new material and a method of preparing the same, which is capable of overcoming the disadvantages of spheroidized natural graphite coated with commercially available amorphous and/or low-crystallinity carbon and utilizing the advantages thereof.

### SUMMARY

### Technical Problem

One embodiment of the present invention is directed to providing a negative electrode active material for a lithium secondary battery with improved stability at high temperatures and excellent cycle characteristics at high temperatures and room temperature.

Another embodiment of the present invention is directed to providing a method of preparing the negative electrode active material for a lithium secondary battery.

Another embodiment of the present invention is directed to providing a lithium secondary battery including the negative electrode active material for a lithium secondary battery.

### Technical Solution

In order to achieve the above technical object, the present invention provides a negative electrode active material for a lithium secondary battery, including spheroidized natural graphite particles, and an amorphous or low-crystallinity carbon coating layer formed on a surface of the spheroidized natural graphite particles, wherein the spheroidized natural graphite particles have a structure in which flaky natural graphite fragment particles are grouped and assembled in a cabbage shape or random shape, and a phosphorus (P) atom is bonded to an edge plane of each of all or some particles of the flaky natural graphite fragment particles.

In one embodiment of the negative electrode active material according to the present invention, preferably, the modified spheroidized natural graphite particles include the flaky natural graphite fragment particles in which the phosphorus (P) atom is selectively bonded only to a surface of the edge plane rather than a base plane.

One embodiment of the negative electrode active material according to the present invention may provide the negative electrode active material for a lithium secondary battery in which a phosphorus compound is selectively adsorbed onto the edge plane of each of all or at least some particles of the flaky natural graphite fragment particles constituting a surface or interior of the spheroidized natural graphite particles, and then the spheroidized natural graphite particles are surface-modified through heat treatment so that a C—O—P or C—P—O bond is formed on a surface of the edge plane of each of the flaky natural graphite fragment particles to modify the spheroidized natural graphite particles, and a surface of the modified spheroidized natural graphite particles are coated with amorphous and/or low-crystallinity carbon.

In this case, the flaky natural graphite fragment particles present on the surface and inside of the modified spheroidized natural graphite particle may include phosphorus (P) in a content of 0.00001 atom % to 2 atom % based on the total number of atoms including a carbon (C) atom constituting the edge plane and the phosphorus (P) atom bonded to the edge plane.

Meanwhile, the coating layer that covers the entirety or portion of the surface of the spheroidized natural graphite particle and includes amorphous and/or low-crystallinity carbon may be included in the negative electrode active material in a content of 1 wt % to 10 wt % based on the total weight of the negative electrode active material.

In addition, another aspect of the present invention provides a method of preparing the negative electrode active material, the method including comprising operation (a) of preparing a solution including spheroidized natural graphite particles having a structure in which flaky natural graphite fragment particles are grouped and assembled in a cabbage shape or random shape, a phosphorus compound, and a solvent, operation (b) of selectively adsorbing a phosphorus compound onto an edge plane of each of all or at least some of the flaky natural graphite fragment particles through an immersing and stirring process in the solution, operation (c) of drying and heat-treating the solution to prepare modified spheroidized natural graphite particles, and operation (d) of coating a surface of the modified spheroidized natural graphite particles with an amorphous and/or low-crystallinity carbon precursor and performing heat treatment to form an amorphous and/or low-crystallinity carbon coating layer.

In this case, the phosphorus compound includes at least one selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

In this case, the solution prepared in operation (a) includes the spheroidized natural graphite particles in a content of 100 parts by weight and the phosphorus compound in a content of 0.000001 parts by weight to 1 part by weight.

In addition, the solution prepared in operation (a) may include a solvent selected from the group consisting of water, ethanol, acetone, methanol, isopropanol, and isopropanol.

In addition, the phosphorus compound adsorption process performed in operation (b) may be performed by immersing and stirring the solution at room temperature for 1 minute to 10 hours and then drying the solvent.

In addition, a drying process in operation (c) may be performed is at least one spray dry method selected from rotary spraying, nozzle spraying, and ultrasonic spraying, a drying method using a rotary evaporator, a vacuum drying method, or a natural drying method.

In addition, the heat treatment in operation (c) may be performed in an atmosphere including air or oxygen, an atmosphere including nitrogen, argon, hydrogen, or a mixed gas thereof, or in a vacuum. When the heat treatment is performed in the atmosphere including nitrogen, argon, hydrogen, or a mixed gas thereof, or in the vacuum, the heat treatment may be performed at a temperature of 200° C. to. 2,000° C., and when the heat treatment is in the atmosphere including air or oxygen, the heat treatment may be performed at a temperature of 200° C. to 600° C.

In addition, in operation (d), a process of applying the amorphous or low-crystallinity carbon precursor may be performed through a wet or dry method.

In addition, a heat treatment process in operation (d) may be performed at a temperature of 600° C. to 2,000° C. in an atmosphere including nitrogen, argon, hydrogen, or a mixture thereof, or in a vacuum.

In addition, as another example of a method of preparing the negative electrode active material, the present invention provides a method of preparing a negative electrode active material for a lithium secondary battery, the method including operation (a) of preparing a solution including spheroidized natural graphite particles having a structure in which flaky natural graphite fragment particles are grouped and assembled in a cabbage shape or random shape, a phosphorus compound, and a solvent, operation (b) of selectively adsorbing a phosphorus compound onto an edge plane of each of all or at least some of the flaky natural graphite fragment particles through an immersing and stirring process in the solution, operation (c) of drying the solution to obtain spheroidized natural graphite particles onto which a phosphorus compound is adsorbed, and operation (d) of coating a surface of the spheroidized natural graphite particles, onto which the phosphorus compound is adsorbed, with an amorphous or low-crystallinity carbon precursor and performing heat treatment to form an amorphous or low-crystallinity carbon coating layer.

In this case, the phosphorus compound includes at least one selected from the group consisting of TCP, TBP, TPP, TEP, trioctyl phosphate, tritolyl phosphite, and tri-isooctylphosphite.

The solution prepared in operation (a) includes the spheroidized natural graphite particles in a content of 100 parts by weight and the phosphorus compound in a content of 0.000001 parts by weight to 1 part by weight.

In addition, the solution prepared in operation (a) may include a solvent selected from the group consisting of water, ethanol, acetone, methanol, isopropanol, and isopropanol.

In addition, the phosphorus compound adsorption process performed in operation (b) may be performed by immersing and stirring the solution at room temperature for 1 minute to 10 hours and then drying the solution.

In addition, a drying process in operation (c) may be performed is at least one spray dry method selected from rotary spraying, nozzle spraying, and ultrasonic spraying, a drying method using a rotary evaporator, a vacuum drying method, or a natural drying method.

In operation (d), a process of applying the amorphous or low-crystallinity carbon precursor may be performed through a wet or dry method.

A heat treatment process in operation (d) may be performed at a temperature of 600° C. to 2,000° C. in an atmosphere including nitrogen, argon, hydrogen, or a mixture thereof, or in a vacuum.

In another aspect of the present invention, there is provided a lithium secondary battery including a negative electrode including the negative electrode active material, a positive electrode, and an electrolyte.

Other details of embodiments of the present invention are incorporated in the detailed description of the present invention described below.

### Advantageous Effects

According to a negative electrode active material for a lithium secondary battery according to the present invention, it is possible to implement a lithium secondary battery with improved stability at high temperature and excellent cycle characteristics at high temperatures and room temperature.

### DESCRIPTION OF DRAWINGS

FIGS. 1A and 1B show results of X-ray photoelectron spectroscopy (XPS) analysis of a sample of highly oriented pyrolytic graphite prepared according to Experimental Example 1 of the present invention.

FIGS. 2A and 2B are scanning electron microscope (SEM) images of spheroidized natural graphite particles which are a pristine sample which is not surface-modified.

FIG. 3 shows a cycle function of a capacity maintenance rate during a charge/discharge cycle at a temperature of 45° C. for each of Examples 1 to 3 and Comparative Example 1.

FIG. 4 shows a cycle function of coulombic efficiency during a charge/discharge cycle at a temperature of 45° C. for each of Examples 1 to 3 and Comparative Example 1.

### DETAILED DESCRIPTION

In describing the present invention, when it is determined that detailed descriptions of a related known function or configuration may unnecessarily obscure the gist of the present invention, the detailed descriptions thereof will be omitted.

Since the embodiments according to the concept of the present invention can be subject to various changes and have various forms, specific embodiments are illustrated in the drawings and described in detail herein. However, it should be understood that this is not intended to limit the embodiments according to the concept of the present invention to specific embodiments, and includes all transformations, equivalents, and substitutes included in the spirit and scope of the present invention.

The terms used in this specification are merely used to describe specific embodiments and are not intended to limit the present invention. An expression of a singular number includes an expression of the plural number, so long as it is clearly read differently. In the present specification, the word “comprise” or “has” is used to specify existence of a feature, a number, a process, an operation, a constituent element, a part, or a combination thereof, and it will be understood that existence or additional possibility of one or more other features or numbers, processes, operations, constituent elements, parts, or combinations thereof are not excluded in advance.

Hereinafter, the present invention will be described in detail.

A negative electrode active material for a lithium secondary battery according to the present invention includes spheroidized natural graphite particles, wherein the spheroidized natural graphite particles have a structure in which flaky natural graphite fragment particles are grouped and assembled in a cabbage shape or random shape, a phosphorus (P) atom is bonded to an edge plane of each of all or at least some particles of the flaky natural graphite fragment particles constituting a surface or interior of the spheroidized natural graphite particles to modify the spheroidized natural graphite particles, and a portion or the entirety of a surface of the modified spheroidized natural graphite particle is coated with amorphous and/or low-crystallinity carbon.

As an example of the negative electrode active material according to the present invention, there is a negative electrode active material for a lithium secondary in which a phosphorus compound is selectively adsorbed onto spheroidized natural graphite and an edge plane of each of flaky natural graphite fragment particles present on a surface and inside of the spheroidized natural graphite to modify the spheroidized natural graphite, and a surface of the modified spheroidized natural graphite particle is coated with amorphous and/or low-crystallinity carbon.

The spheroidized natural graphite particles may be formed by a method disclosed in Korean Patent Publication Nos. 2003-0087986 and 2005-0009245, but the present invention is limited thereto. For example, an operation of repeatedly processing flaky natural graphite with an average particle diameter of 30 μm or more using a rotary machine is performed to aggregate particles of the flaky natural graphite through pulverization by a collision between an inner surface of the rotary machine and powders of the flaky natural graphite, friction processing between the powders, and shearing of the powders through shear stress, thereby finally preparing spheroidized natural graphite particles.

In this way, the spheroidized natural graphite particles may be formed by grouping and aggregating flaky natural graphite fragment particles in a cabbage shape or random shape. More preferably, the spheroidized natural graphite particles may be formed by grouping and aggregating flaky natural graphite fragment particles on a surface in a cabbage shape or at a central portion in a random shape.

In addition, the spheroidized natural graphite particles may have a circular shape as well as an elliptical shape, and more specifically, may have a spheroidized shape in which an index calculated by projecting three-dimensional natural graphite particles onto a two-dimensional plane is about 0.8 or more.

An average particle diameter (D50) of the spheroidized natural graphite particles may be in a range of 5 μm to 40 μm, specifically, in a range of 7 μm to 30 μm. D50 refers to an average diameter of particles of which a cumulative volume corresponds to 50 wt % in a particle size distribution. When spheroidized natural graphite particles having an average particle diameter in such a range is used, a process of grouping and aggregating flaky natural graphite fragment particles in a cabbage shape or random shape may be easy, and electrochemical properties may be improved.

According to one embodiment of the present invention, there is provided a negative electrode active material for a lithium secondary battery in which a phosphorus compound is selectively adsorbed onto the edge plane of each of all or at least some particles of the flaky natural graphite fragment particles constituting the surface or interior of the spheroidized natural graphite particles to modify the surface of the spheroidized natural graphite particles through heat treatment so that a C—O—P or C—P—O bond is formed on a surface of the edge plane, and an amorphous and/or low-crystallinity carbon coating layer is included in the entirety or at least a portion of a surface of the modified spheroidized natural graphite particle.

The surface of the edge plane of the flaky natural graphite fragment particle may include phosphorus (P) in a content of 0.00001 atom % to 2 atom % and more preferably in a range of 0.0001 atom % to 1 atom % based on the total number of atoms including a carbon (C) atom constituting the surface of the edge plane and a phosphorus (P) atom bonded to the surface of the edge plane.

When a content of phosphorus (P) is in such a range and the surface of the modified spheroidized natural graphite particle includes the amorphous and low-crystallinity carbon coating layer, the edge plane of each of all or at least some particles of the flaky natural graphite fragment particles constituting the surfaces or interiors of the spheroidized natural graphite particles is effectively surface-modified, and since the surface of the spheroidized natural graphite particle includes the amorphous and low-crystallinity carbon coating layer, the electrical conductivity and structural stability of the spheroidized natural graphite particles are improved, resulting in excellent lifespan characteristics at high temperature and room temperature.

In the spheroidized natural graphite particles, the flaky natural graphite particles are physically aggregated using mechanical energy through pulverization by a collision between the flaky natural graphite powders, friction processing between powders, and shearing of the powders through shear stress, and thus are present between the flaky natural graphite fragment particles constituting the spheroidized natural graphite particles.

A molecular weight of the phosphorus compound is very small, and thus during an adsorption process, a solution including the phosphorus compound may flow into the micro-gaps between the flaky natural graphite fragment particles constituting the spheroidized natural graphite particles. As a result, the phosphorus compound may be selectively adsorbed onto the edge plane of each of all or at least some particles of the flaky natural graphite fragment particles present on the surface and inside of the spheroidized natural graphite particles.

The negative electrode active material according to the present invention described above may be prepared through the following method.

An example of a method of preparing the negative electrode active material may include operation (a) of preparing a solution including spheroidized natural graphite particles having a structure in which flaky natural graphite fragment particles are grouped and assembled in a cabbage shape or random shape, a phosphorus compound, and a solvent, operation (b) of selectively adsorbing a phosphorus compound onto an edge plane of each of all or at least some of the flaky natural graphite fragment particles present on a surface and inside of the spheroidized natural graphite particles through an immersing and stirring process in the solution, operation (c) of drying the solution and heat-treating the dried spheroidized natural graphite particles to prepare modified spheroidized natural graphite particles, and operation (d) of coating a surface of the modified spheroidized natural graphite particles with an amorphous and/or low-crystallinity carbon precursor and performing heat treatment to form an amorphous and/or low-crystallinity carbon coating layer.

In this case, the phosphorus compound may include at least one selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

In addition, the solution prepared in operation (a) may include the spheroidized natural graphite particles in a content of 100 parts by weight and the phosphorus compound in a content of 0.000001 parts by weight to 1 part by weight.

That is, the phosphorus compound used for such an adsorption process may be included in a content of 0.000001 parts by weight to 1 part by weight and more preferably in a content of 0.00001 parts by weight to 0.5 parts by weight based on 100 parts by weight of the spheroidized natural graphite particles. When the content of the phosphorus compound exceeds 1 part by weight, resistance to charge transfer on a surface of the spheroidized natural graphite particles increases, and thus output characteristics and cycle characteristics may deteriorate. When the content of the phosphorus compound is less than 0.000001 parts by weight, an effect of modifying the spheroidized natural graphite particles may be insufficient.

In addition, the solution prepared in operation (a) may include a solvent selected from the group consisting of water, ethanol, acetone, methanol, isopropanol, and isopropanol.

In addition, a process of adsorbing the phosphorus compound performed in operation (b) may be performed by immersing and stirring the solution at room temperature for 1 minute to 10 hours and then drying solution.

In addition, a drying process in operation (c) may be performed is at least one spray dry method selected from rotary spraying, nozzle spraying, and ultrasonic spraying, a drying method using a rotary evaporator, a vacuum drying method, or a natural drying method.

In addition, the heat-treating in operation (c) may be performed in an atmosphere including air or oxygen, an atmosphere including nitrogen, argon, hydrogen, or a mixed gas thereof, or in a vacuum.

When the heat-treating is performed in an atmosphere including nitrogen, argon, hydrogen, or a mixed gas thereof, or in a vacuum, the heat-treating may be performed at a temperature of 200° C. to. 2,000° C., and when the heat-treating is in an atmosphere including air or oxygen, the heat-treating may be performed at a temperature of 200° C. to 600° C.

In operation (d), the amorphous or low-crystallinity carbon precursor may include citric acid, stearic acid, sucrose, polyvinylidene fluoride, carboxymethylcellulose (CMC), hydroxypropylcellulose, regenerated cellulose, polyvinylpyrrolidone, tetramethylcellulose, polyethylene, polypropylene, an ethylene-propylene-diene monomer (EPDM), sulfonated EPDM, starch, a phenol resin, a furan resin, furfuryl alcohol, polyacrylic acid, sodium polyacrylate, polyacrylonitrile, polyimide, an epoxy resin, cellulose, styrene, polyvinyl alcohol, polyvinyl chloride, coal-based pitch, petroleum-based pitch, mesophase pitch, low molecular weight heavy oil, glucose, gelatin, saccharides, or a combination thereof. However, the present invention is not limited to the types of the carbon precursor.

In operation (d), the application of the amorphous or low-crystallinity carbon precursor may be performed through a wet or dry method.

In operation (d), the heat treatment may be performed in an atmosphere containing nitrogen, argon, hydrogen, or a mixture thereof, or in a vacuum.

In operation (d), the heat treatment may be performed at a temperature of 600° C. to 2,000° C. and specifically at a temperature of 800° C. to 1,500° C. When the heat treatment is performed at a temperature in such a range, different elements corresponding to impurities may be sufficiently removed during a process of carbonizing the carbon precursor, and irreversible capacity is reduced accordingly, resulting in excellent charge/discharge characteristics. When the heat treatment temperature is performed at a temperature exceeding 2,000° C., most of the adsorbed phosphorus compound is decomposed and removed, and thus an effect of modifying the spheroidized natural graphite particles may be insufficient.

Another example of a method of preparing a negative electrode active material according to the present invention may include operation (a) of preparing a solution including spheroidized natural graphite particles having a structure in which flaky natural graphite fragment particles are grouped and assembled in a cabbage shape or random shape, a phosphorus compound, and a solvent, operation (b) of selectively adsorbing a phosphorus compound onto an edge plane of each of all or at least some of the flaky natural graphite fragment particles present on a surface and inside of the spheroidized natural graphite particles through an immersing and stirring process in the solution, operation (c) of drying the solution to obtain spheroidized natural graphite particles onto which the phosphorus compound is adsorbed, and operation (d) of coating a surface of the spheroidized natural graphite particles with an amorphous and/or low-crystallinity carbon precursor and then forming an amorphous and low-crystallinity carbon coating layer through heat treatment.

In this case, the phosphorus compound includes at least one selected from the group consisting of TCP, TBP, TPP, TEP, trioctyl phosphate, tritolyl phosphite, and tri-isooctylphosphite.

The solution prepared in operation (a) may include the spheroidized natural graphite particles in a content of 100 parts by weight and the phosphorus compound in a content of 0.000001 parts by weight to 1 part by weight.

In addition, the solution prepared in operation (a) may include a solvent selected from the group consisting of water, ethanol, acetone, methanol, isopropanol, and isopropanol.

In addition, a process of adsorbing the phosphorus compound performed in operation (b) may be performed by immersing and stirring the solution at room temperature for 1 minute to 10 hours and then drying the solution.

In addition, a drying process in operation (c) may be performed through at least one spray dry method selected from rotary spraying, nozzle spraying, and ultrasonic spraying, a drying method using a rotary evaporator, a vacuum drying method, or a natural drying method.

In operation (d), the amorphous or low-crystallinity carbon precursor may include citric acid, stearic acid, sucrose, polyvinylidene fluoride, CMC, hydroxypropylcellulose, regenerated cellulose, polyvinylpyrrolidone, tetramethylcellulose, polyethylene, polypropylene, an EPDM, sulfonated EPDM, starch, a phenol resin, a furan resin, furfuryl alcohol, polyacrylic acid, sodium polyacrylate, polyacrylonitrile, polyimide, an epoxy resin, cellulose, styrene, polyvinyl alcohol, polyvinyl chloride, coal-based pitch, petroleum-based pitch, mesophase pitch, low molecular weight heavy oil, glucose, gelatin, saccharides, or a combination thereof. However, the present invention is not limited to the types of the carbon precursor.

In operation (d), the application of the amorphous and low-crystallinity carbon precursor may be performed through a wet or dry method.

In operation (d), the heat treatment may be performed in an atmosphere containing nitrogen, argon, hydrogen, or a mixture thereof, or in a vacuum.

In operation (d), the heat treatment may be performed at a temperature of 600° C. to 2,000° C. and specifically at a temperature of 800° C. to 1,500° C. When the heat treatment is performed at a temperature in such a range, different elements corresponding to impurities may be sufficiently removed during a process of carbonizing the carbon precursor, and irreversible capacity is reduced accordingly, resulting in excellent charge/discharge characteristics.

Meanwhile, the total amount of the amorphous and/or low-crystallinity carbon coating layer may be in a range of 1 wt % to 10 wt % and more preferably in a range of 3 wt % to 7 wt % based on the total amount of the negative electrode active material. When the amorphous and low-crystallinity carbon is included in such a range, the application of the amorphous and/or low-crystallinity carbon is effectively achieved, thereby exhibiting excellent properties of a negative electrode active material.

Furthermore, in another aspect of the present invention, there is provided a lithium secondary battery including a negative electrode including the negative electrode active material, a positive electrode, and an electrolyte.

Lithium secondary batteries may be classified into lithium ion batteries, lithium ion polymer batteries, and lithium polymer batteries according to types of used separators and electrolytes, may be classified into cylindrical, prismatic, coin type, pouch type secondary batteries according to shapes, and may be classified into bulk type and thin film type secondary batteries according to sizes. The structures and manufacturing methods of these batteries are widely known in the art, and thus detailed descriptions are omitted.

The negative electrode may be manufactured by mixing the above-described negative electrode active material, a binder, and optionally a conductive material to prepare a composition for forming a negative electrode active material layer, and then applying the composition on a negative electrode current collector. The components of these negative electrode are widely known in the art, and thus detailed descriptions are omitted.

### Modes of the Invention

Hereinafter, for describing the present application in detail, the present application will be described in detail with reference to Examples. However, Examples according to the present application may be modified in various forms, and it is understood that the scope of the present application is not limited to Examples to be described in detail below. The Examples of the present application are provided for more completely describing the present application to those skilled in the art.

### Example 1

100 parts by weight of spheroidized natural graphite particles (manufactured by POSCO Chemical Co., Ltd.) with an average particle diameter (D50) of 16 μm and 0.005 parts by weight of TCP were added to ethanol, stirred for 30 minutes and then dried. Then, spheroidized natural graphite modified particles obtained through heat treatment at a temperature of 800° C. for 30 minutes in a nitrogen atmosphere were carbonized, and then petroleum-based pitch based on 1 wt % of residual carbon was applied on a surface of the spheroidized natural graphite modified particles, heat-treated at a temperature of 1,000° C. for 1 hour in a nitrogen atmosphere, and then furnace-cooled, thereby preparing spheroidized natural graphite particles coated with amorphous and low-crystallinity carbon.

### Example 2

100 parts by weight of spheroidized natural graphite particles (manufactured by POSCO Chemical Co., Ltd.) with an average particle diameter (D50) of 16 μm and 0.005 parts by weight of TCP were added to ethanol, stirred for 30 minutes and then dried. Then, spheroidized natural graphite modified particles obtained through heat treatment at a temperature of 800° C. for 30 minutes in a nitrogen atmosphere were carbonized, and then petroleum-based pitch based on 3 wt % of residual carbon was applied on a surface of the spheroidized natural graphite modified particles, heat-treated at a temperature of 1,000° C. for 1 hour in a nitrogen atmosphere, and then furnace-cooled, thereby preparing spheroidized natural graphite particles coated with amorphous and low-crystallinity carbon.

### Example 3

100 parts by weight of spheroidized natural graphite particles (manufactured by POSCO Chemical Co., Ltd.) with an average particle diameter (D50) of 16 μm and 0.005 parts by weight of TCP were added to ethanol, stirred for 30 minutes and then dried. Then, spheroidized natural graphite modified particles obtained through heat treatment at a temperature of 800° C. for 30 minutes in a nitrogen atmosphere were carbonized, and then petroleum-based pitch based on 5 wt % of residual carbon was applied on a surface of the spheroidized natural graphite modified particles, heat-treated at a temperature of 1,000° C. for 1 hour in a nitrogen atmosphere, and then furnace-cooled, thereby preparing spheroidized natural graphite particles coated with amorphous and low-crystallinity carbon.

### Comparative Example 1

A product, which was prepared by applying amorphous and low-crystallinity carbon on a surface of spheroidized natural graphite particles with an average particle diameter (D50) of 16 μm and was provided by POSCO Chemical Co., Ltd., was used as a negative electrode active material.

### Experimental Example 1

A sample of highly oriented pyrolytic graphite and 5 wt % of TCP based on the highly oriented pyrolytic graphite were added to ethanol, stirred at room temperature for 30 minutes, and then dried. Then, heat treatment was performed at temperatures of 300° C. and 400° C. for 1 hour in an air atmosphere.

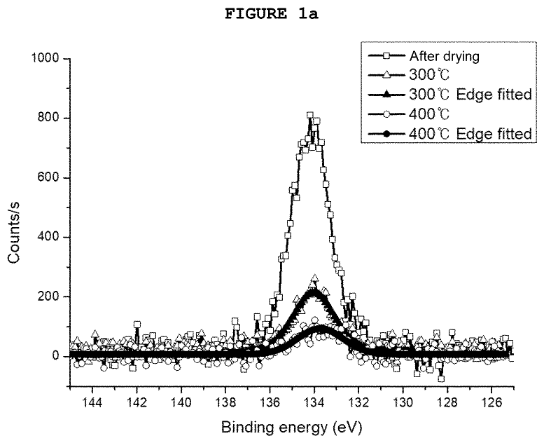

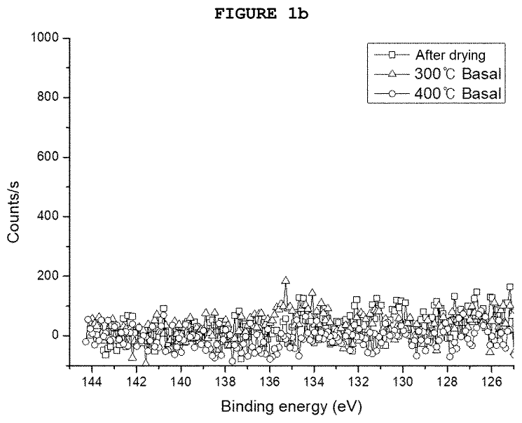

FIG. 1 shows results of X-ray photoelectron spectroscopy (XPS) analysis of the highly oriented pyrolytic graphite prepared according to Experimental Example 1. When TCP was adsorbed onto the sample of the highly oriented pyrolytic graphite and then heat-treated at temperatures of 300° C. and 400° C. for 1 hour in an air atmosphere, as shown in FIG. 1A, a bond related to a phosphorus (P) element was formed on an edge plane, but the bond related to the phosphorus (P) element was not formed on a basal plane (see FIG. 1B). Thus, it can be seen that the phosphorus compound of the present invention is selectively adsorbed onto an edge plane of artificial graphite, and after drying, as a temperature of subsequent heat treatment increases, the phosphorus compound adsorbed onto the edge plane is decomposed, resulting in a decrease in the bond related to the phosphorus (P) element. The P element positioned on the edge plane of a graphite surface forms a C—P—O or C—O—P bond.

### Evaluation: Analysis of Scanning Electron Microscopy (SEM) Image

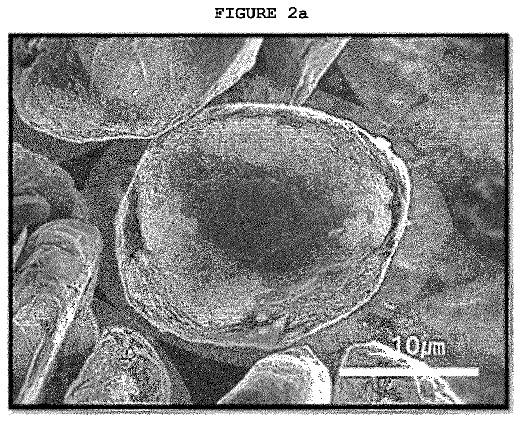

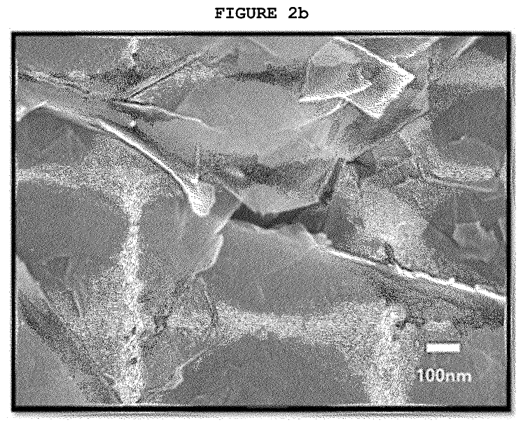

FIGS. 2A and 2B are SEM images of spheroidized natural graphite particles which are a pristine sample which has an average particle diameter (D50) of 16 μm and is not surface-modified.

Micro-gaps are present between the spheroidized natural graphite fragment particles constituting the spheroidized natural graphite particles are physically aggregated using mechanical energy through pulverization by a collision between the flaky natural graphite powders, friction processing between powders, and shearing of the powders through shear stress (in particular, see FIG. 2B). Accordingly, in the case of a phosphorus compound with a small molecular weight, a molecular weight is very small, and thus during an adsorption process of the phosphorus compound, which is a modification process, a solution including the phosphorus compound flows into the micro-gaps between the flaky natural graphite fragment particles constituting the spheroidized natural graphite particles. Thus, it can be seen that the phosphorus compound may be selectively adsorbed onto an edge plane of each of the flaky natural graphite fragment particles present on a surface and inside of the spheroidized natural graphite particles.

### (Manufacturing of Test Cell)

A negative electrode slurry was prepared by mixing each of the negative electrode active materials prepared in Examples 1 to 3 and Comparative Example 1 with carboxymethyl cellulose/styrene-butadiene rubber (CMC/SBR) in distilled water at a weight ratio of 96:4. The negative electrode slurry was applied on copper foil and then dried and pressed to prepare each negative electrode.

By using the negative electrode and lithium metal as a positive electrode, a separator (Celgard®) was interposed between the negative electrode and the positive electrode, and the negative electrode, the separator, and the positive electrode were stacked to manufacture an electrode assembly. Afterwards, an electrolyte in which 1M LiPF6 was dissolved in a mixed solvent of ethylene carbonate (EC) and ethylmethyl carbonate (EMC) (EC:EMC=2:8) was added to manufacture a test cell (2016 type coin cell).

### Evaluation: Analysis of Lifespan Characteristics

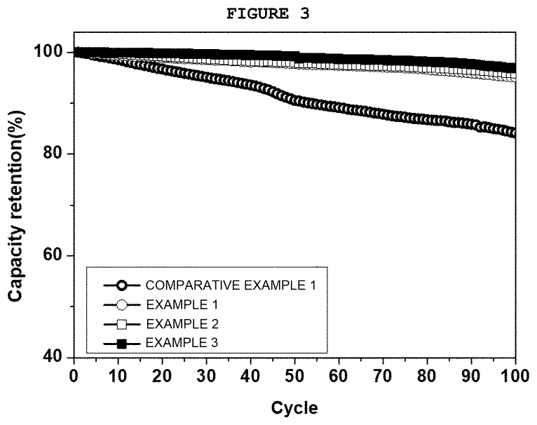

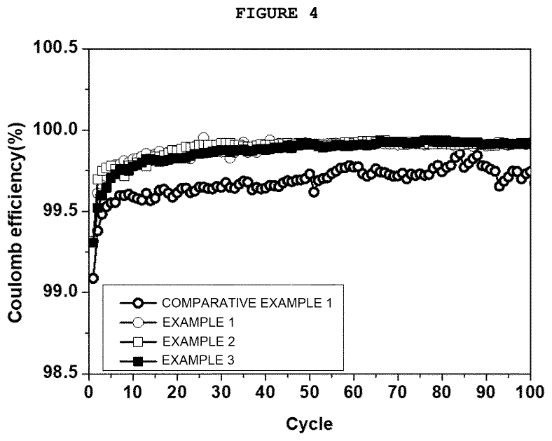

By using the manufactured test cell, charge/discharge lifespan characteristics were evaluated at a temperature of 45° C. for each of Examples 1 to 3 and Comparative Example 1 through the following method. Results thereof are shown in Table 1 and FIGS. 3 and 4.

Charge/discharge cycle characteristics were evaluated for 3 cycles at room temperature after a formation process. Charging was performed in a constant current (CC)/constant voltage (CV) mode at a 0.5-C rate, and a termination voltage was maintained at 0.005 V. Discharging was performed at a CC/CV mode at a 0.5-C rate, and a termination voltage was maintained at 1.5 V.

TABLE 1

| | | | Capacity |
|---|---|---|---|
| | | | retention rate (%) at |
| | Initial capacity | Initial | 45° C. after |
| | (mAh/g) | efficiency (%) | 100 cycles |
| Example 1 | 363.4 | 92.7 | 95.2 |
| Example 2 | 363 | 92.7 | 95.8 |
| Example 3 | 362.5 | 92.9 | 96.8 |
| Comparative | 360.6 | 93.2 | 84.1 |
| Example 1 | | | |

Through Table 1, in the case of Examples 1 to 3 using a negative electrode active material which is surface-modified with TCP and is also coated with carbon, as compared to Comparative Example 1 using a negative electrode active material in which a surface of spheroidized natural graphite is coated only with carbon, it can be confirmed that the lifespan characteristics are excellent. In particular, in the case of Examples 1 to 3, it can be seen that a decrease in capacity due to surface modification is small, a capacity retention rate is almost 95% or more even after 100 cycles at a temperature of 45° C., and very excellent high-temperature lifespan characteristics are exhibited as compared to Comparative Example 1 which is currently used as a commercial product.

FIG. 3 shows a cycle function of a capacity maintenance rate during a charge/discharge cycle at a temperature of 45° C. for each of Examples 1 to 3 and Comparative Example 1.

FIG. 4 shows a cycle function of coulombic efficiency during a charge/discharge cycle at a temperature of 45° C. for each of Examples 1 to 3 and Comparative Example 1. As compared to Comparative Example 1 which is a commercial graphite anode active material, the coulombic efficiency during the charge/discharge cycle appears to be superior.

### Evaluation: Analysis of Electrode Swelling Characteristics

By using the manufactured test cell, charge/discharge lifespan characteristics were evaluated for 100 cycles at a temperature of 45° C. for each of Examples 1 to 3 and Comparative Example 1, and then a change in thickness of an electrode was measured. Results thereof are shown in Table 2 below.

TABLE 2

| | Electrode expansion ratio (%) |
|---|---|
| Example 1 | 30.1 |
| Example 2 | 29.6 |
| Example 3 | 28.4 |
| Comparative Example 1 | 34.5 |

Referring to the results in Table 2, it can be confirmed that Examples 1 to 3 have superior electrode expansion characteristics during a charge/discharge cycle at a temperature of 45° C. as compared to Comparative Example 1 which is the currently commercial product.

The above Examples are believed to be because, since an edge plane of each of the flaky graphite fragment particles present on a surface and inside of the spheroidized natural graphite particles is effectively surface-modified to secure the stability of a surface of the edge plane of each of the flaky graphite fragment particles, and a surface of the spheroidized natural graphite particles is coated with amorphous and low-crystallinity carbon to secure the structural stability of the spheroidized natural graphite particles and also improve electrical conductivity so that side reactions with an electrolyte are effectively suppressed on the edge plane of each of the flaky graphite fragment particles present on the surface and inside of the spheroidized natural graphite particles even when charging/discharging is repeated at high temperature.

As a result, according to spheroidized natural graphite in which the edge plane of each of the flaky graphite fragment particles present on the surface and inside of the spheroidized natural graphite particles is surface-modified using a phosphorus compound, and also the surface of the spheroidized natural graphite particles is coated with amorphous or low-crystallinity carbon, it is possible to implement a lithium secondary battery with excellent lifespan characteristics at room temperature and high temperature.

The present invention is not limited to the above-described embodiments, but an anode active material for a lithium secondary battery may be prepared in various different forms. Those skilled in the art will understand that the present invention may be implemented in another specific form without changing the technical spirit or an essential feature thereof. Accordingly, it should be understood that the above-described embodiments are exemplary in all respects and not restrictive.

### INDUSTRIAL APPLICABILITY

According to a negative electrode active material for a lithium secondary battery according to the present invention, it is possible to implement a lithium secondary battery with improved stability at high temperature and excellent cycle characteristics at high temperatures and room temperature.

1. A negative electrode active material for a lithium secondary battery, comprising:
spheroidized natural graphite particles; and
an amorphous or low-crystallinity carbon coating layer formed on a surface of the spheroidized natural graphite particles,
wherein the spheroidized natural graphite particles have a structure in which flaky natural graphite fragment particles are grouped and assembled in a cabbage shape or random shape, and
a phosphorus (P) atom is bonded to an edge plane of each of all or some particles of the flaky natural graphite fragment particles.

2. The negative electrode active material of claim 1, wherein the phosphorus (P) atom is bonded only to a surface of the edge plane rather than a basal plane of each of the flaky natural graphite fragment particles.

3. The negative electrode active material of claim 1, wherein the phosphorus (P) atom is bonded to a surface of the edge plane of each of the flaky natural graphite fragment particles in a form of C—O—P or C—P—O.

4. The negative electrode active material of claim 1, wherein the flaky natural graphite fragment particles to which the phosphorus (P) atom is bonded include phosphorus (P) in a content of 0.00001 atom % to 2 atom % based on the total number of atoms including a carbon (C) atom constituting the edge plane and the phosphorus atom bonded to the edge plane.

5. The negative electrode active material of claim 1, wherein a content of the amorphous or low-crystallinity carbon coating layer formed on the surface of the spheroidized natural graphite particles is in a range of 1 wt % to 10 wt % based on a total weight of the negative electrode active material.

6. A method of preparing a negative electrode active material for a lithium secondary battery, the method comprising:
operation (a) of preparing a solution including spheroidized natural graphite particles having a structure in which flaky natural graphite fragment particles are grouped and assembled in a cabbage shape or random shape, a phosphorus compound, and a solvent;
operation (b) of selectively adsorbing a phosphorus compound onto an edge plane of each of all or at least some of the flaky natural graphite fragment particles through an immersing and stirring process in the solution;
operation (c) of drying the solution and heat-treating to prepare modified spheroidized natural graphite particles; and
operation (d) of coating a surface of the modified spheroidized natural graphite particles with an amorphous or low-crystallinity carbon precursor and performing heat treatment to form an amorphous or low-crystallinity carbon coating layer.

7. A method of preparing a negative electrode active material for a lithium secondary battery, the method comprising:
operation (a) of preparing a solution including spheroidized natural graphite particles having a structure in which flaky natural graphite fragment particles are grouped and assembled in a cabbage shape or random shape, a phosphorus compound, and a solvent;
operation (b) of selectively adsorbing a phosphorus compound onto an edge plane of each of all or at least some of the flaky natural graphite fragment particles through an immersing and stirring process in the solution;
operation (c) of drying the solution to obtain spheroidized natural graphite particles onto which a phosphorus compound is adsorbed; and
operation (d) of coating a surface of the spheroidized natural graphite particles, in which the phosphorus compound is selectively adsorbed onto an edge plane of each of all or at least some of the flaky natural graphite fragment particles, with an amorphous or low-crystallinity carbon precursor and performing heat treatment to form an amorphous or low-crystallinity carbon coating layer.

8. The method of claim 6, wherein the phosphorus compound includes at least one selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

9. The method of claim 6, wherein, in operation (a), the solution includes the spheroidized natural graphite particles in a content of 100 parts by weight and the phosphorus compound in a content of 0.000001 parts by weight to 1 part by weight.

10. The method of claim 6, wherein the solvent is selected from the group consisting of water, ethanol, acetone, methanol, isopropanol, and isopropanol.

11. The method of claim 6, wherein the amorphous or low-crystallinity carbon precursor includes citric acid, stearic acid, sucrose, polyvinylidene fluoride, carboxymethylcellulose (CMC), hydroxypropylcellulose, regenerated cellulose, polyvinylpyrrolidone, tetrafluoroethylene, polyethylene, polypropylene, an ethylene-propylene-diene monomer (EPDM), sulfonated EPDM, starch, a phenol resin, a furan resin, furfuryl alcohol, polyacrylic acid, sodium polyacrylate, polyacrylonitrile, polyimide, an epoxy resin, cellulose, styrene, polyvinyl alcohol, polyvinyl chloride, coal-based pitch, petroleum-based pitch, mesophase pitch, low molecular weight heavy oil, glucose, gelatin, saccharides, or a combination thereof.

12. The method of claim 6, wherein the heat-treating in operation (c) is performed at a temperature of 200° C. to 2,000° C. in an atmosphere including nitrogen, argon, hydrogen, or a mixed gas thereof, or in a vacuum or is performed at a temperature of 200° C. to 600° C. in an atmosphere including air or oxygen, and
the heat treatment in operation (d) is performed at a temperature of 600° C. to 2,000° C. in an atmosphere including nitrogen, argon, hydrogen, or a mixed gas thereof, or in a vacuum.

13. The method of claim 7, wherein the heat treatment in operation (d) is performed at a temperature of 600° C. to 2,000° C. in an atmosphere including nitrogen, argon, hydrogen, or a mixed gas thereof, or in a vacuum.

14. A lithium secondary battery comprising:
a negative electrode including the negative electrode active material of claim 1;
a positive electrode; and
an electrolyte.
